(19) United States
(12) Patent Application Publication
(10) Pub. No.: US 2011/0073141 A1
(43) Pub. Date: Mar. 31, 2011

(54) RECEIVING CONTAINER FOR A CLEANER CARTRIDGE AND DISHWASHER

(75) Inventors: Helmut Jerg, Giengen (DE); Kai Paintner, Adelsried (DE)

(73) Assignee: BSH BOSCH UND SIEMENS HAUSGERÄTE GMBH, Munich (DE)

(21) Appl. No.: 12/992,897

(22) PCT Filed: Jun. 18, 2009
(86) PCT No.: PCT/EP2009/057615

§ 371 Date: Nov. 16, 2010

(30) Foreign Application Priority Data
Jun. 23, 2008 (DE) 10 2008 029 427.6
Oct. 10, 2008 (DE) 10 2008 042 758.6

(51) Int. Cl. B08B 3/00

(52) U.S. Cl. 134/115 R

(57) ABSTRACT

A receiving container in a dishwasher. The receiving container has a dish unit and a swiveled flap unit to receive a cleaner cartridge that has a plurality of reservoirs for liquid cleaning agents. The receiving container also has an outlet slot in a bottom area of the dish unit for the liquid cleaning agents to be discharged once the liquid cleaning agents have been metered from the reservoirs of the cleaner cartridge.

In the case of a dishwasher, an operating person has thus far filled up a metering chamber in the door or a wall of the internal container of the dishwasher with a cleaning agent in powder form anew for each rinsing cycle. In this process, if required the salt and the rinse aid are added at larger intervals only after a plurality of rinsing cycles in separate metering chambers supplied for each. As an alternative to said loose, i.e. individually replenishable cleaning agents, the dishwasher can also be stocked with so-called “cleaner tabs” or cleaner tablets for a subsequent desired rinsing cycle. Said “cleaner tabs” contain a plurality of cleaning agents, rinse aids and if required salt in a preferred manner. Both of the above filling types of a dishwasher with different cleaning agents determine that the user is required to fill up the relevant cleaning agent at the right time for a desired rinsing cycle and dispense it in a corresponding manner. Over and above that, the user may easily forget to buy a single cleaning agent at the right time. In practice, it may therefore happen that a single cleaning agent runs out and cannot be filled up by the user for a desired rinsing cycle so that a faultless rinsing operation of the dishwasher is impossible.

The object underlying the present invention is thus to record a way in which in a simple and automated manner, liquid cleaning agents can be introduced in the internal container of a dishwasher faultlessly to a large degree. The object is achieved in accordance with the invention in that a receiving container in a dishwasher comprises a dish unit and a swiveled flap unit for receiving a cleaner cartridge, said cleaner cartridge having a plurality of reservoirs for liquid cleaning agents, and said receiving container also comprises an outlet slot in the bottom area of the dish unit for allowing the liquid cleaning agents to be discharged once they have been metered from the reservoirs of the cleaner cartridge.

By means of such an outlet slot in the bottom area of the dish unit of the receiving container it is invariably ensured that the liquid cleaning agents can run out from the receiving container, when they have been released selectively from their reservoirs in the cleaner cartridge and flow out of it because of their gravity. By means of the outlet slot in the bottom area of the dish unit, the individually apportioned or metered out liquid cleaning agents from the receiving container can arrive to a large extent unimpeded in the internal container of the dishwasher. Over and above that, the outlet slot makes it possible that while the dishwasher is running, a jet of water from at least one spray arm and/or another spraying device can hit through the outlet slot into the inside of the receiving container and can there wash out the liquid cleaning agents released by the cleaner cartridge to a large extent in a complete manner. As a result of this, it is to a large extent prevented that residues of the liquid cleaning agents released by the cleaner cartridge can remain undissolved inside the receiving container or in the outlet slot, which could lead to an undesirable clogging of the outlet openings of the reservoirs of the cleaner cartridge. In this way, the relevant liquid cleaning agent or the relevant cleaner components, which are selectively metered out from the relevant reservoir of the cleaner cartridge in a preferred manner, can be introduced to a large extent in a complete manner into the internal container of the dishwasher and mixed or blended there with water into a desired rinsing solution compound. By means of said finely metered out, automatic as well as in particular selective apportioning of individual liquid cleaning agents from a plurality of reservoirs of a cleaner cartridge, the composition of the rinsing solution can be adjusted in a defined way for the relevant rinsing cycle. In particular, as a function of loading and soiling of the rinsing goods introduced in the internal container of the dishwasher at specific points in time of the cleaning process the relevant liquid cleaning agent or cleaner agent can be added specifically to the rinsing solution. For this reason, a visibly improved cleaning result can be obtained compared with conventional dishwasher rinsing agents.

Because of the fact that the flap unit of the receiving container can swing away, the cleaner cartridge can be exchanged in a simple and clean way, without the user being exposed to the liquid cleaning agents themselves. Once a new cleaner cartridge has been filled up with liquid cleaning agents or cleaner agents in the receiving container and the swiveled flap unit has been closed, the cleaner cartridge is to a large extent protected against mechanical damage or other mechanical wear. In this way, the functionality of the cleaner cartridge is always ensured until the liquid cleaning agents have been used fully.

In accordance with a first suitable development of the invention, the receiving container is provided at or in a side wall extending into the depth of the internal container of the dishwasher in a preferred manner. The receiving container is in particular integrated with its dish unit into the side wall in such a way that the flap unit closes in its final closing position to a large extent flush with the remaining surface of said side wall. Because of the fact that the receiving container is fitted at or in the side wall of the dishwasher, it is freely accessible for an operating person from the outside through the front opening of the internal container of the dishwasher, which makes it easy to replace an old and used cleaner cartridge with a new and full cleaner cartridge.

In accordance with a further suitable development of the invention, the flap unit is fitted at the dish unit in particular in a swiveled manner so that in the closed state of the flap unit, an outlet slot is formed and opened between the lower edge of the flap unit and the lower outer edge section of the dish unit. For this reason, an outlet slot is formed in a particularly simple way at the base of the receiving container in a constructive manner.

In accordance with a further suitable development of the invention, the lower outer edge section of the dish unit, which forms its floor or receiving chamber base, is tilted in the upright built-in state of the receiving container downwards towards the floor of the internal container of the dishwasher. By means of this bevel or slope of the lower outer edge section of the dish unit, the liquid cleaning agents or cleaner components released in a selective manner from the different reservoirs because of their gravity can run forwards to the outlet slot and from there drip downwards. Because of this, it is ensured in an advantageous way that the entire metered amount of the relevant cleaning agent released flows i.e. can arrive to a large extent in a complete manner into the internal container of the dishwasher. This, on the one hand, leads to better rinsing results because the metered amount of the relevant apportioned cleaning agent in fact also arrives in the internal container. On the other hand, it is to a large extent prevented in this way that residues of the metered amount of the relevant apportioned cleaner component remain in the receiving container and cause contamination there for example because of hardening or clogging.

In accordance with a further suitable development of the invention, the swivel axis of the flap unit in the area of the lower outer edge section of the dish unit is provided in such a way that the flap unit in its opening end position forms a kind of support tray or support table for the cleaner cartridge to be inserted. This in particular facilitates the handling when stocking the receiving container with a new cleaner cartridge, because it can be placed on the flap unit and can be carried or held by it. To this end, it is in particular suitable that the flap unit is stopped in its opening end position or secured in its position. This is in particular achieved in accordance with an advantageous development of the invention in a simple way in that the swivel axis of the flap unit is arranged in the lower area close to the bottom of the dish unit in such a way that in the opening end position of the flap unit said lower edge area strikes against the front side area of the lower outer edge section of the dish unit, i.e. forms an interconnection with it and thereby limits the movement of the swinging open of the flap unit. In essence, the flap unit is aligned in particular in its opening end position horizontally or at an angle downwards in the direction of the floor of the rinsing container of the dishwasher so that it forms a kind of support table for the cleaner cartridge.

In accordance with a further advantageous development of the invention, the flap unit comprises on the inside one mounting element or a plurality of mounting elements, which serves to fasten the cleaner cartridge in its position. By means of this, the cleaner cartridge can, in a very simple way, once the flap unit has been closed, be brought into a desired, predetermined activation position, in which the metering mechanism of the individual, separate reservoirs of the cleaner cartridge is released. In said activation position, the cleaner cartridge is in particular upright, i.e. its side walls in essence run in a vertical direction. In said activation position, in which the cartridge is to a large extent in a complete manner integrated or inserted in the box-shaped dish unit, the outlet openings of the reservoirs lie in the area of the lower outer edge of the dish unit. The reservoirs of the cleaner cartridge are then in particular aligned in such a way that in essence a vertical preferred outflow direction is set each time for said liquid cleaner components under the effect of gravity.

Other developments of the invention are given in the subclaims.

The invention and its developments as well as its advantages are described in more detail below:

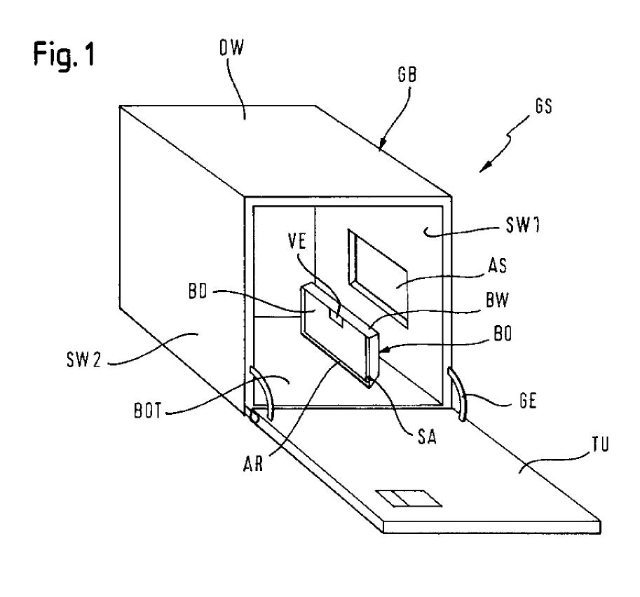

FIG. 1 shows in a perspective representation, a dishwasher with an exemplary embodiment of a receiving container for a cleaner cartridge devised in accordance with the invention,

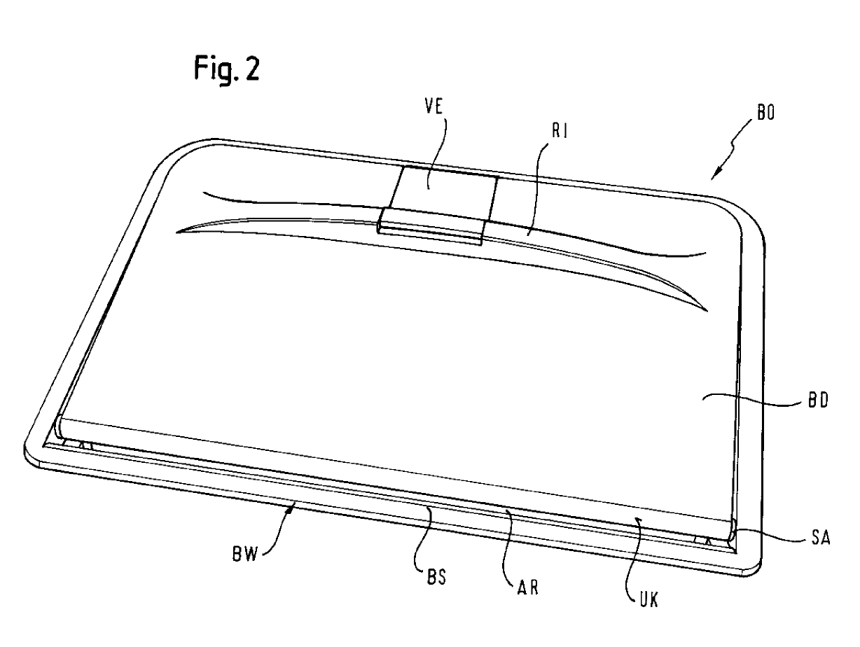

FIG. 2 shows in a schematic representation as an individual item, the receiving container of FIG. 1 in the closed state, and

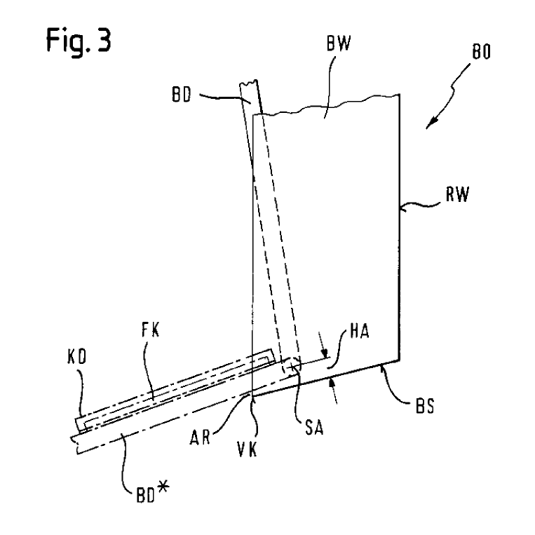

FIG. 3 shows schematically in a side view, the receiving container of FIGS. 1 and 2.

In the FIGS. 1 to 3, the same reference characters refer to the same or functionally comparable components.

FIG. 1 shows schematically in a perspective representation, an exemplary embodiment of a dishwasher GS that has a square internal container or a rinsing container GB. This comprises four wall parts, in essence both vertical side walls SW1, SW2 as well as the cover part DW that is to a large extent arranged in a horizontal manner as well as the bottom part BOT that is in essence aligned in a horizontal manner. The internal container GB comprises on the front, a rectangular opening, which can be closed by means of a door TU. In this process, the door TU is hinged in a swiveling manner by means of an articulated device GE in the area of the bottom part BOT on both side walls SW1, SW2. Here in the exemplary embodiment, provision has been made for a rectangular incision or a recess AS in the right side wall SW1, into which the dish unit BW of a receiving container or a receiving box BO is inserted, in particular fitted in. In FIG. 1, the receiving container BO is only shown in the pre-mounting state, i.e. before its insertion into the incision AS as an individual component in the closed state. For this, a plastic material is used in a preferred manner. In this process, the dish unit BW of the receiving container BO is to a large extent integrated liquid-tight and vapor-tight in the incision AS and forms a part of the surface of the outer wall SW1. The receiving container BO has a flat, square geometric shape in a preferred manner. The outer contour of said dish unit BW is, in essence, rectangular and selected in such a way that it is adapted to the inner contour of the receiving section AS in the side wall SW1. The thickness of the receiving container BO is in particular selected in such a way that the front flap unit BD of the receiving container BO facing the inner space of the internal container GB is to a large extent flush with the remaining wall surface of the side wall SW1, when the receiving container BO is fitted in the finished state in the cutout or in the recess AS. This has the advantage that the receiving container AB in the built-in state has no parts that protrude from the side wall SW1 into the inner space of the internal container GB, which would limit the space in the internal container GB. Because of this, the rotating spray arms as well as other moving parts retain their full freedom of movement in the internal container GB of the dishwasher GS. Constructional changes of the spray arms, crockery baskets and/or other moving components are also avoided in an advantageous manner.

If required, in the case of sufficient spatial volume in the internal container GB it is also possible to place the receiving container BO as an auxiliary component on the side wall SW1 on the inside and to leave out the recess AS. The receiving container BO then protrudes inwards facing the flat inner side of the side wall SW1.

As an alternative, instead of an incision AS in the side wall SW1 passing through to the outside, provision can also be made for a depression shaped outwards, which receives the receiving container in a partial or complete manner. Said depression has for this purpose a square, inner geometric shape dome-shaped towards the outside, which corresponds to the outer geometric shape of the square receiving container BO to a large extent.

The receiving container BO consists of two partial components: the upright, i.e. vertically aligned dish unit BW and the flap unit BD fitted in a hinged or swiveled manner thereon. The flap unit BD is suspended in the bottom area of the dish unit BW on a swivel axis SA in a rotary manner. The swivel axis SA is shaped here in an exemplary embodiment by two bolts or pin elements, which are fitted, in particular integrally molded, in the area of the receiving chamber base of the receiving container BO at its vertically developing outer edge sections and face each other horizontally inside the receiving container BO protruding in a preferred manner. These lie flush against each other in a preferred manner. Both said bolt elements in each case engage in an assigned, correspondingly shaped groove or in a blind hole in the closed state of the receiving container in essence into the vertically developing inner edges of the flap cover in such a way that said flap cover is mounted in a rotary manner with regard to the intended straight line of the two mounting bolts.

The swivel axis SA of the flap unit BD is arranged in such a way in the lower area close to the bottom of the dish unit BW that, in the closing end position of the flap unit between its lower edge and the lower outer edge section or the bottom of the dish unit BW, an outlet slot AR is formed. FIG. 2 shows the receiving container BO in a schematic representation as an individual item in the closed state. In essence, the outlet slot AR covers the total clear width of the dish unit BW. Said slot runs in essence in the depth direction of the rinsing container IB and is designed in essence in a linear manner. Said slot height is for practical reasons selected in such a way that a water jet of at least one spray arm or another spraying device in the internal container GB of the dishwasher GS can penetrate through the elongated slot AR into the inside of the receiving container BO and in this process can spray out and clean in particular the outlet slot AR. A cleaner cartridge KD, which has a plurality of reservoirs with liquid cleaning agents or cleaner components, is accommodated on the inside of the receiving container BO. By means of an actuating device, which can be provided on the cleaner cartridge itself, inside the receiving container BO, and/or at the outside of the rear wall of the receiving container, defined metered amounts of liquid cleaning agents can be removed from the reservoirs in a selective manner, i.e. separately or independently from each other. Through the outlet slot AR in the bottom area of the dish unit it is now ensured that the relevant liquid cleaning agent released from the receiving container BO can drip out or flow out and can mix or blend with the rinsing solution in the sump of the floor pan of the internal container GB. Through the outlet slot AR it is in particular possible that a water jet, which is ejected through at least one spraying device such as for example a self-rotating spray arm, which can each time wash out and to a large extent remove completely the cleaner agent released by the cleaner cartridge from the inside of the receiving container. Because of this it is to a large extent prevented that liquid cleaning agent residues remain inside the receiving container BO and/or in the outlet slot and can for example clog there by hardening.

To summarize, the outlet slot or the outlet groove AR, therefore makes it possible that the relevant cleaning agent component released can to a large extent exit residue-free from the receiving container BO and can be introduced to a large extent in a complete manner with regard to its released metered amount into the rinsing solution. In this way, a fine metering of the relevant liquid rinsing component or the cleaner component into the inner space GB is made possible. In addition, it is also ensured that once the relevant rinsing cycle has ended, the relevant cleaner cartridge in the receiving container is washed clean. It can thus be removed relatively free from contamination by cleaning agents by an operating person once the rinsing program has ended. Through the outlet slot it is in addition ensured to a large extent that the cleaner cartridge can also be dried during the drying step of the relevant rinsing program.

The flap unit BD has in the center of its upper edge, a catch VE as a fastener that on the inside tensions, in particular catches on, the outer edge of the dish unit BW in a resilient manner. By moving the resilient catch VE backwards into an open position, the flap unit can be swiveled or opened to inside the internal container GB. In this process, the swivel axis SA of the flap unit BD is arranged in such a way in the lower area close to the bottom of the dish unit BW that in the opening end position of the flap unit between its rear edge and the front edge of the lower outer edge sections of the dish unit BW, a support zone is formed in order to limit the opening movement of the flap unit BD. The flap unit BD then functions as a support table for the cleaner cartridge, which makes it easier to remove or insert a newly filled-up cleaner cartridge. It is in particular practical to fit the flap unit BD in such a way in the bottom area of the dish unit BW in a swiveled manner, that it is in its opening end position to a large extent aligned in a horizontal manner, i.e. in essence protrudes at right angles to the side wall SW1 inwards into the inner space of the internal container GB.

The flap unit BD shows along its lower edge as well as along its two vertical side edges, an inner edge DR which projects inwards, in essence vertical to the inner surface of the flap unit BD. In the closed state of the receiving container BO, this inner edge DR of the flap unit BD engages in the space defined by the outer edge AR of the dish unit BW. In particular, the flap unit shows an inner edge at its upper edge and both its longitudinal side edges, which engage in the closing end position of the flap unit in a correspondingly circumferential groove in the dish unit. Said groove has been left out in FIGS. 1 to 3 for reasons of diagrammatic clarity.

The lower outer edge or the floor BS of the dish unit BW fitted upright runs in a preferred manner sloping downwards in the direction of the bottom BOT of the internal container GB. This is illustrated in the side view diagram of the receiving container in FIG. 3. The lower outer edge BS of the dish unit BW is facing with its rear wall RW sloped downwards by more than 90°. Because of this the relevant liquid cleaning agent released can on the basis of its own weight run towards the front outlet slot AR and from there drip downwards on its own to the bottom BOT of the internal container GB. Even when no water jet can penetrate through the outlet slot AR into the inside of the receiving container BO, the metered amount of the relevant liquid cleaning agent released each time can, based on its own weight, slide on its own forwards to the front opening of the outlet slot AR and in this way drip down from there into the inside of the internal container GB. The swivel axis SA for the flap unit BD is arranged in the area of the dish unit BW close to the bottom in a preferred manner. It has at right angles to the sloped bottom BS of the dish unit BW a given vertical interval HA in such a way that a fixed-gap clearance is made available between the swivel axis and the rotating axis SA and the inner side of the bottom BS to discharge the relevant liquid cleaning component released each time. In this process, the swivel axis SA of the flap unit BD is arranged in the area of the lower outer edge section of the dish unit BW in such a way that the flap unit BD in said opening end position lies flush with the lower outer edge section BS to a large extent.

Said opening end position is plotted in FIG. 3 as a dot-dash line designated with the reference symbol BD*. In this process, a support zone or an interconnecting area is formed in said opening end position between the rear edge of the flap unit BD* and the front edge of the lower outer edge section BS of the dish unit BW, by means of which the revolving movement of the flap unit is limited. This is due to the swivel axis SA being shifted back upwards by a lateral distance that can be predefined compared with the lower edge UK of the flap unit BD and this therefore brings about a proportionate overlapping or interconnection in the opening end position of a boundary area on the outside in the area of the lower edge UK of the flap unit and a boundary area on the inside of the lower outer edge section of the dish unit BW. Therefore, the flap unit in said opening end position can now serve as a support table for the cleaner cartridge, which is secured against a support pressure from above. In addition, the flap unit BD has one holding device or a plurality of holding devices FK, in particular guiding links by means of which the relevant cleaner cartridge KD can position itself in a desired place in a preferred manner. In FIG. 3, the cartridge KD as well as the holding device FK are simply plotted both as dot-dash lines and diagrammatically.

Because of the fact that the flap unit has one mounting element or a plurality of mounting elements on the inside, which serve to secure the cleaner cartridge in its place, the cleaner cartridge can be brought in a particularly simple way after the closing of the flap unit into a desired, predetermined activation position in which the metering mechanism of the individual, separate reservoirs of the cleaner cartridge is cleared. In said activation position, the cleaner cartridge is in particular upright, i.e. said side walls in essence run in a vertical direction. In said activation position, in which the cartridge is to a large extent integrated or fitted in a complete manner into the box-type dish unit, the outlet openings of the reservoirs are in the area of the lower outer edge of the dish unit. The reservoirs of the cleaner cartridge are then in particular aligned in such a way that an in essence preferred vertical outflow direction is set for the liquid cleaner components in each case.

1-22. (canceled)

23. A receiving container in a dishwasher, the receiving container comprising:
a dish unit;
a swiveled flap unit to receive a cleaner cartridge that has a plurality of reservoirs for liquid cleaning agents; and
an outlet slot in a bottom area of the dish unit for the liquid cleaning agents to be discharged once the liquid cleaning agents have been metered from the reservoirs of the cleaner cartridge.

24. The receiving container of claim 23, wherein the flap unit is arranged on the dish unit in a swiveled manner such that, in a closed state of the flap unit, the outlet slot is open to a predetermined extent.

25. The receiving container of claim 23, wherein the outlet slot is between a lower edge of the flap unit and a lower outer edge section of the dish unit.

26. The receiving container of claim 23, wherein the outlet slot essentially extends over a clear width of the dish unit.

27. The receiving container of claim 23, wherein a slot height of the outlet slot is selected such that a spray jet of at least one of a spray arm and another spraying device in an internal container of the dishwasher hits on the inside of the receiving container.

28. The receiving container of claim 27, wherein the slot height is between 0.5 mm and 10 mm.

29. The receiving container of claim 28, wherein the slot height is between 1 mm and 5 mm.

30. The receiving container of claim 23, wherein in each of two lateral side walls of the flap unit a respective guiding link is provided to laterally guide, mount and activate a respective and inserted cleaner cartridge.

31. The receiving container of claim 23, wherein, in an area of a lower outer edge section of the dish unit, a swivel axis of the flap unit is provided such that, in an opening end position of the flap unit, the flap unit lies, to a predetermined extent, flush with a lower outer edge section of the dish unit.

32. The receiving container of claim 23, wherein a swivel axis of the flap unit is arranged in a lower area close to the bottom of the dish unit such that, in an opening end position of the flap unit, a support zone is formed between a boundary area on an outside along a lower edge of the flap unit and a front edge of a lower outer edge section of the dish unit to limit a movement of swinging the flap unit open.

33. The receiving container of claim 23, wherein, by two bolt elements, the flap unit is arranged in a swiveled manner by two bolt elements on the inside of side walls of an outer edge of the dish unit.

34. The receiving container of claim 23, wherein a snapping element in an area of a top edge of the flap unit latches the flap unit in a closing end position of the flap unit to a top outer edge section of the dish unit.

35. The receiving container of claim 23, wherein the dish unit is essentially a flat square box having an outer edge all around the flap square box that protrudes in the direction of the flap unit.

36. The receiving container of claim 23, wherein the flap unit is a flat square box, which has, except for a lower edge of the flat square box, an inner edge that protrudes in the direction of the dish unit and that is opposite of a support area of the flat square box.

37. The receiving container of claim 23, wherein the flap unit has an inner edge at a top edge of the flap unit and at two longitudinal side edges of the flap unit, wherein the inner edge engages in a groove in the dish unit that corresponds, in a closing end position of the flap unit, to the inner edge.

38. The receiving container of claim 36, wherein, in a closing end position of the flap unit, the inner edge of the flap unit is, to a predetermined extent, fitted in a sunken manner on the inside of the dish unit, and wherein, on the outside, the inner edge is surrounded by an outer edge.

39. The receiving container of claim 23, wherein, in an upper partial half of the flap unit, the flap unit has a longitudinal rib as a gripping aid, which runs in a longitudinal direction of the dish unit and which protrudes into the inner space of an internal container of the dishwasher.

40. The receiving container of claim 23, wherein, in an opening end position of the flap unit, the flap unit is mounted in a swiveled manner on the dish unit such that the flap unit forms a support table for a cleaner cartridge that is to be inserted.

41. The receiving container of claim 23, wherein, in a mounting position of the dish unit in the dishwasher, a lower outer edge section of the dish unit slopes, with reference to a vertical rear wall of the dish unit slopes, downwards in the direction of a bottom of an internal container of the dishwasher.

42. The receiving container of claim 23, wherein, in a mounting state of the dish unit, the dish unit is essentially vertically aligned in a side wall of the dishwasher.

43. A dishwasher having a receiving container, the receiving container comprising:
a dish unit;
a swiveled flap unit to receive a cleaner cartridge that has a plurality of reservoirs for liquid cleaning agents; and
an outlet slot in a bottom area of the dish unit for the liquid cleaning agents to be discharged once the liquid cleaning agents have been metered from the reservoirs of the cleaner cartridge.

44. The receiving container of claim 43, wherein the receiving container is in one of a recess and on the inner surface of one of a side wall and a rear wall of a rinsing container.

45. The receiving container of claim 43, wherein the receiving container is essentially vertically arranged such that the flap unit is mounted in a swiveled manner with reference to a swivel axis, and wherein the swivel axis runs essentially in a horizontal plane.
